(19) United States
(12) Patent Application Publication
(10) Pub. No.: US 2015/0225631 A1
(43) Pub. Date: Aug. 13, 2015

(54) Resin Composition, Application Method Thereof and Liquid Crystal Display Panel Using Same

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Ang XIAO, Beijing (CN)

(21) Appl. No.: 14/500,282

(22) Filed: Sep. 29, 2014

(30) Foreign Application Priority Data
Feb. 12, 2014 (CN) 201410048835.4

(51) Int. Cl. C09K 3/10; G02F 1/1335; G02F 1/1339; C08F 122/20

(52) U.S. Cl. CPC C09K 3/1006; C08F 122/20; G02F 1/133514; G02F 1/1339; C09K 2003/1062; C09K 2200/0625; C09K 2200/0647

(57) ABSTRACT

The invention discloses a resin composition, use method thereof, and a LCD panel using the same, which can solve the problem of poor display in a peripheral display area caused by denaturization of liquid crystal in that area upon exposure to UV light of 320-380 nm adopted for UV radiation of resin compositions in the prior art. The resin composition of the invention is photocurable under an irradiation of visible light having a wavelength in the range of 400-450 nm, which will not cause the denaturization of liquid crystal. Thus, the distance from the edge of the mask to the display area can be decreased, which is advantageous for the reduction of the width of the frame of a LCD panel.

### FIELD OF THE INVENTION

The present invention relates to the technical field of materials. More particularly, the present invention relates to a resin composition, its application method, and a liquid crystal display (LCD) panel using the resin composition.

### BACKGROUND OF THE INVENTION

Narrow-frame LCDs have become one of the most attractive research topics in the display field, due to their aesthetic appearance and larger display area. Generally, the frame size of an LCD panel is determined by the width of the sealant used, the cutting accuracy, the distance from the edge of the mask used to the outer edge (the edge close to the cutting boundary) of display area of the panel, and the distance from the edge of the mask to the inner edge (the edge close to the display area) of the sealant, as shown in FIG. 1. The sealant is typically a resin composition which is photocured by exposure to ultraviolet (UV) light (wavelength range: 320-380 nm). However, the UV light having a wavelength within that range tends to denature the liquid crystal at the peripheral display area upon UV exposure, for which the distance from the edge of the mask to the outer edge of the display area need be increased (typically, to an extent of greater than 0.2 mm). Thus, decreasing the distance from the edge of the mask to the outer edge of the display area will be advantageous for the reduction of the width of the frame of the LCD panel. The existing technical solutions are generally directed to the development of liquid crystal materials resistant to UV light in the range of 320-380 nm. However, such solutions are relatively cost expensive and the effects thereof are limited.

### SUMMARY OF THE INVENTION

An object of the present invention is to solve the problem that the resin compositions of the prior art need to be cured by an irradiation of the light having a wavelength in the range of 320-380 nm which denatures the liquid crystals. The object is achieved by providing a resin composition which is photocurable under an irradiation of visible light (wavelength range: 400-450 nm).

The resin composition according to the present invention comprises an epoxy acrylic resin represented by the following Formula (I):

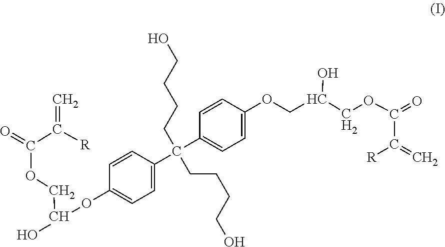

wherein each R is independently a hydrogen atom, or an alkyl substituent having a carbon atom number of less than 6.

Preferably, the alkyl substituent having a carbon atom number of less than 6 is any one selected from methyl, ethyl, n-propyl, isopropyl, n-butyl, isobutyl, tert-butyl, n-pentyl, isopentyl and neopentyl.

The resin composition may further comprise a photoinitiator capable of inducing a photocuring reaction of the epoxy acrylic resin under the irradiation of visible light, particularly, the visible light having a wavelength in the range of 400-450 nm.

Preferably, the resin composition further comprises, in addition to the epoxy acrylic resin:

an epoxy resin;

a photoinitiator;

a coupling agent;

a heat curing agent;

an organic filler;

an inorganic filler; and

optionally, a heat-resistant anion exchange resin.

The epoxy resin preferably has a number-average molecular weight in the range of 380-1000.

The photoinitiator is preferably camphorquinone or N,N-dimethylaminoethyl methacrylate-diaryliodonium salt.

The coupling agent is preferably a silane coupling agent. For example, the silane coupling agent may be any one selected from kh550, kh560 and kh570.

The organic filler is preferably an organic pellet filler having a D₉₀ particle size in the range of 0.1-1.0 μm.

More preferably, the organic pellet filler is selected from rubber pellets and acrylic resin pellets.

The inorganic filler is preferably an inorganic pellet filler having a D₉₀ particle size in the range of 0.1-1.0 μm.

More preferably, the inorganic pellet filler is silica pellet.

The resin composition preferably comprises 60-70% of the epoxy acrylic resin, based on the total mass of the resin composition.

More preferably, the resin composition further comprises, based on the total mass of the resin composition:

5% -7% of the epoxy resin;

0.1% -0.5% of the photoinitiator;

0.5% -1% of the coupling agent;

10% -15% of the heat curing agent;

4% -6% of the organic filler;

5% -11% of the inorganic filler; and

0% -2%, more preferably 0.5% -2%, of the heat-resistant anion exchange resin.

Another object of the present invention is to provide an LCD panel, comprising an array substrate, a color filter substrate, and a sealant bonding the array substrate and the color filter substrate, wherein the sealant is the cured resin composition as described above.

Yet another object of the present invention is to provide a method of applying the resin composition, for example, as a sealant in an LCD panel. The method comprises the steps of providing the resin composition of the present invention and irradiating the resin composition with visible light to induce photocuring of the composition. Preferably, the visible light has a wavelength in the range of 400-450 nm.

The resin composition according to the present invention is photocurable under an irradiation of visible light (wavelength range: 400-450 nm). Therefore, curing of the composition will not cause the denaturation of the liquid crystal at the peripheral display area, such that the distance from the edge of the mask to the outer edge of the display area can be decreased, which is advantageous for reduction of the width of the frame of an LCD panel.

### BRIEF DESCRIPTION OF THE FIGURES

FIG. 1 is a schematic diagram showing the respective portions constituting the width of the frame of an LCD panel of the prior art.

FIG. 2 is the molecular structure formula of the epoxy acrylic resin of an embodiment according to the present invention.

FIG. 3 is a schematic diagram showing the process of measuring the reactivity ratio of an acrylic resin according to the present invention.

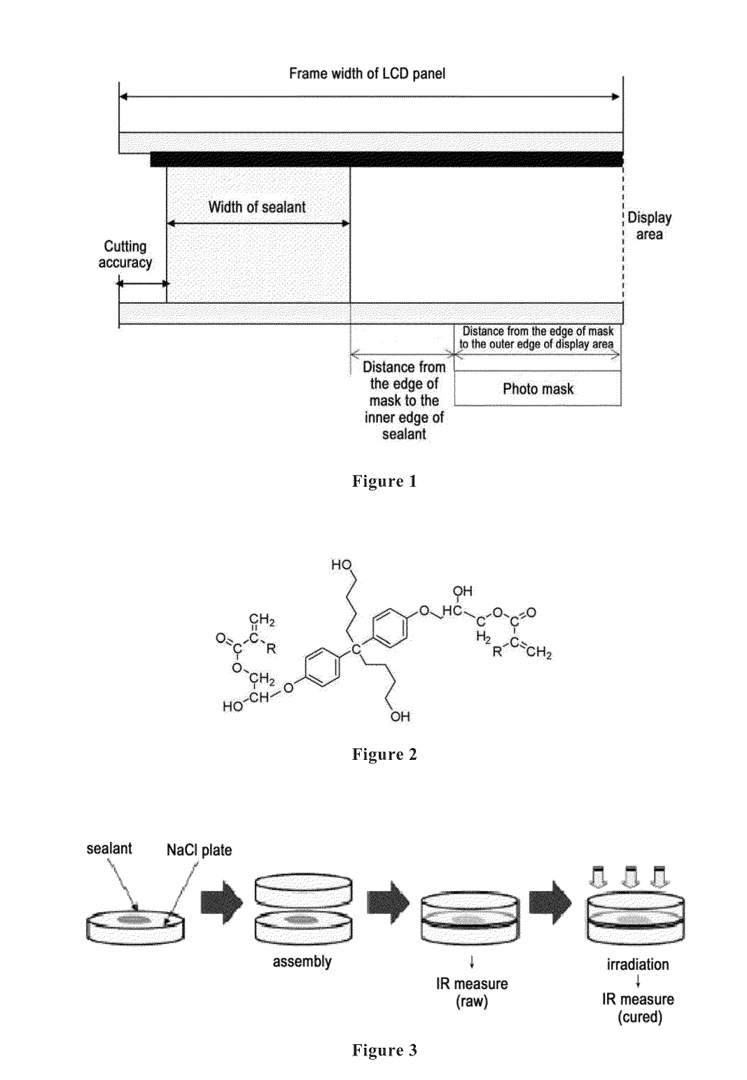

### DETAILED DESCRIPTION OF CERTAIN EMBODIMENTS

In order to make those skilled in the art have a better understanding of the technical solutions of the present invention, more detailed description is provided below with reference to specific embodiments and the accompanying drawings.

An embodiment of the present invention provides a resin composition comprising an epoxy acrylic resin having a structure formula as shown in FIG. 2 (i.e., the Formula (I) described hereinbefore), wherein each R is independently a hydrogen atom, or an alkyl substituent having a carbon atom number of less than 6.

Preferably, the alkyl substituent having a carbon atom number of less than 6 is any one selected from methyl, ethyl, n-propyl, isopropyl, n-butyl, isobutyl, tert-butyl, n-pentyl, isopentyl and neopentyl.

Preferably, the epoxy acrylic resin is present at an amount of 60-70% by mass of the resin composition.

The epoxy acrylic resin may be prepared by reacting an epoxy compound of the following Formula (II) with an acrylic compound of the following Formula (III):

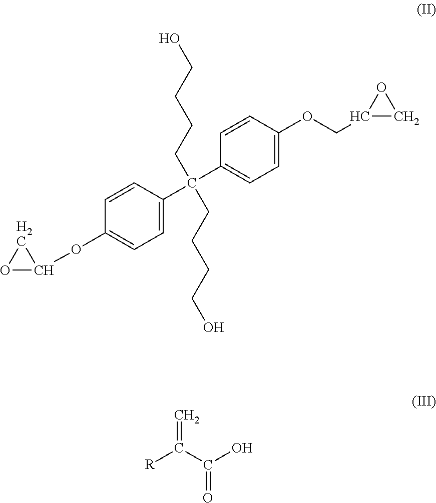

wherein each R is independently a hydrogen atom, or an alkyl substituent having a carbon atom number of less than 6.

More specifically, the process for preparing the epoxy acrylic resin may comprise the following steps:

(1) mixing the compound of Formula (II) with a polymerization inhibitor to obtain a mixture 1, wherein the inhibitor may be selected from those commonly used in the art, such as p-hydroxyanisole;

(2) mixing the compound of Formula (III) with a catalyst to obtain a mixture 2, wherein the catalyst may be selected from those commonly used in condensation reactions, such as tetraethylammonium bromide;

(3) adding the mixture 2 dropwise to the mixture 1 under stirring at a temperature of 40-100° C., preferably, slowly adding the mixture 2 dropwise (for example, at a rate of 1 to 2 drops per second) to the mixture 1 under stirring at a temperature of 70-100° C.; and

(4) after completion of the addition, keeping the reaction for another 6-10 hours at a temperature of 80-120° C., preferably, for another 8-10 hours at a temperature of 100-1202 C.

The resin composition may further comprise a photoinitiator capable of inducing the epoxy acrylic resin to undergo a photocuring reaction under the irradiation of visible light, particularly, the visible light having a wavelength in the range of 400-450 nm. The photoinitiator is preferably camphorquinone or N,N-dimethylaminoethyl methacrylate-diaryliodonium salt. Preferably, the photoinitiator is present at an amount of 0.1% -0.5% by mass of the resin composition.

The resin composition may further comprise an additional epoxy resin and a heat curing agent. The term “additional epoxy resin” or “epoxy resin” as used herein refers to epoxy resin(s) other than the epoxy acrylic resin of Formula (I). Preferably, the epoxy resin is selected from bisphenol A type epoxy resin, p-aminophenol triglycidyl epoxy resin, tetrahydrophthalic acid diglycidyl ester epoxy resin, hexahydrophthalic acid diglycidyl ester, and combinations thereof. The epoxy resin may comprise at least one of E-51 and E-41. Preferably, the heat curing agent is an organic amine, such as methylene bis(cyclohexylamine), diethylenetriamine, triethylenetetramine, etc. Preferably, the epoxy resin is present at an amount of 5% -7% by mass of the resin composition. Preferably, the heat curing agent is present at an amount of 10% -15% by mass of the resin composition.

The resin composition may further comprise an organic filler and/or inorganic filler. The resin composition may also comprise a coupling agent as desired. The organic filler is preferably an organic pellet filler having a D₉₀ particle size in the range of 0.1-1.0 μm. Unless indicated otherwise, the term “D₉₀ particle size” used herein refers to a particle size below which the particle sizes of about 90% of the particles in a given particle size distribution fall. More preferably, the organic pellet filler is selected from rubber pellets and acrylic resin pellets. The inorganic filler is preferably an inorganic pellet filler having a D₉₀ particle size in the range of 0.1-1.0 μm. More preferably, the inorganic pellet filler is silica pellet. The coupling agent is preferably a silane coupling agent. For example, the silane coupling agent may be any one selected from kh550, kh560 and kh570 (all commercially available from Union Carbide Corporation). Preferably, the organic filler is present at an amount of 4% -6% by mass of the resin composition. Preferably, the inorganic filler is present at an amount of 5% -11% by mass of the resin composition. Preferably, the coupling agent is present at an amount of 0.5% -1% by mass of the resin composition.

The resin composition may optionally comprise a heat-resistant anion exchange resin. Preferably, the heat-resistant anion exchange resin can withstand a temperature up to 200° C. The heat-resistant anion exchange resin may be those commercially available from KaiRui Chemical Co., Ltd, particularly KRNW series resins, and more preferably, KRNW925. The heat-resistant anion exchange resin may be present at an amount of 0% -2%, preferably 0.5% -2%, by mass of the resin composition.

Preferably, the resin composition comprises: the epoxy acrylic resin; the epoxy resin; the photoinitiator; the coupling agent; the heat curing agent; the organic filler; the inorganic filler; and, optionally, the heat-resistant anion exchange resin.

The resin composition may comprise 60-70% of the epoxy acrylic resin, based on the total mass of the composition. The resin composition may further comprise:

5% -7% of the epoxy resin;

0.1% -0.5% of the photoinitiator;

0.5% -1% of the coupling agent;

10% -15% of the heat curing agent;

4% -6% of the organic filler;

5% -11% of the inorganic filler; and

0% -2%, more preferably 0.5% -2%, of the heat-resistant anion exchange resin.

In the resin compositions provided by the embodiments of the present invention, the epoxy acrylic resins having the structure described above exhibit higher reactivity ratio of acrylic resin at a wavelength in the range of 400-450 nm. The epoxy acrylic resin is present preferably at an amount of 60-70% by mass of the resin composition. In the case that the amount of the epoxy acrylic resin is below 60%, the heat-curing reaction will become slow and the sealant cannot be cured quickly during the process of one-drop filling, such that the sealant tends to break when the liquid crystal expands upon heating. On the other hand, when the amount of the epoxy acrylic resin is above 70%, the sealant cannot exhibit sufficient bonding strength. In addition, the amount of the epoxy resin typically ranges from 5% to 7%, because the bonding strength of the sealant becomes weak when its amount is below 5%, or the sealant tends to break as the heat-curing reaction becomes slow when its amount is above 7%. The heat-resistant anion exchange resin is used mainly for absorbing impurity ions and small molecules in the resin composition.

The resin composition according to the present invention exhibits an excellent bonding strength (higher reactivity ratio of acrylic resin) at a wavelength in the range of 400-450 nm, and meanwhile, avoids the problem of denaturization of liquid crystal caused by polymerization of conventional sealant resin compositions under the irradiation at a wavelength of 320-380 nm.

The present invention also provides a method of preparing the resin composition, comprising the following steps:
compounding step, wherein the components of the resin composition are mixed in the proportion as described above and compounded at a temperature of 30-50° C.; and
deaerating step, wherein the compounded mixture is deaerated at least twice at a pressure less than 200 Pa, each for 30-50 minutes.

Preferably, the compounding operation may be performed twice or thrice, and the compounding time may be determined by the mass of the resin composition. Further, the above steps are preferably performed in the yellow-light zone.

Generally, the viscosity of the resin composition may be finally adjusted to 150-250 Pa·s by varying the amount of low-viscosity epoxy resin within the range of its content in the resin composition. Unless indicated otherwise, the term “viscosity” used herein refers to a viscosity at room temperature, typically measured by a spinning viscometer (commercially available from Brookfield Co.). The epoxy resin may have a number-average molecular weight in the range of 380-1000, and examples thereof include E-51 and E-41.

The deaerated resin composition is filtered, sealed, and preserved away from light for further use, wherein the sealing step is performed in an environment having a cleaness degree of Class 1000 (defined according to China National Standard GB/T 16292-1996). Preferably, all the operations other than the compounding step may be carried out at room temperature.

The present invention also provides a method of applying the resin composition, for example, as a sealant in an LCD panel, and an LCD panel obtained thereby. The method comprises the steps of providing the resin composition of the present invention and irradiating the resin composition with visible light to induce curing of the composition. In the case that the resin composition is used as a sealant in an LCD panel, the method of the present invention comprises the steps of applying the resin composition onto the frame of a color filter substrate and/or array substrate, and irradiating the resin composition with visible light to induce curing of the composition. Preferably, the visible light has a wavelength in the range of 400-450 nm.

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly indicates otherwise.

### EXAMPLES

Advantages and embodiments of the present invention are further illustrated by the following examples, but the particular materials and amounts thereof recited in these examples, as well as other conditions and details, should not be construed to unduly limit the invention.

The materials and devices used in the examples are described below:

p-hydroxyanisole: available from Beijing Chemical Plant;

Acrylic acid, methacrylic acid, isopropyl acrylic acid, neopentyl acrylic acid: available from Guangzhou Tianzhong Chemical Co. Ltd.;

Tetraethylammonium bromide: available from Longsheng Fine Chemical Co. Ltd.;

Compound of Formula (II): available from Guangzhou Dute Chemical Co. Ltd.;

Bisphenol A type epoxy resin, p-aminophenol triglycidyl epoxy resin, tetrahydrophthalic acid diglycidyl ester epoxy resin, hexahydrophthalic acid diglycidyl ester: available from Dow Chemical Company;

Camphorquinone, N,N-dimethylaminoethyl methacrylate-diaryliodonium salt: available from J&K Chemical Ltd.;

kh550, kh560, kh570: available from Union Carbide Corporation;

Methylene bis(cyclohexylamine), diethylenetriamine, triethylenetetramine: available from Shenyang Dongsheng Chemical Co. Ltd.;

Rubber pellets, acrylic resin pellets, silica pellets: available from Dow Chemical Company;

Horizontal helical ribbon mixer: Manufactured by Shanghai Kairi Machinery Manufacture Co. Ltd.;

Twin screw extruder: Manufactured by Nanjing Keya Co. Ltd.

Materials and devices available from other sources can be used as well.

### Example 1

This example provides a resin composition and a method of preparing the same. The resin composition comprises, based on the total mass of the composition:

60% of the epoxy acrylic resin represented by the formula shown in FIG. 2 wherein each R is a hydrogen atom;

6.9% of bisphenol A epoxy resin as an epoxy resin;

0.1% of camphorquinone as a photoinitiator;

1% of silane coupling agent kh550 as a coupling agent;

15% of diethylenetriamine as a heat curing agent;

4% of rubber pellets having a D₉₀ particle size of 1.0 μm as an organic filler;

11% of silica pellets having a D₉₀ particle size of 0.1 μm as an inorganic filler; and

2% of KRNW925 (available from Kairui Chemical Co., Ltd.) as a heat-resistant anion exchange resin.

The epoxy acrylic resin was prepared by the following process. 100 g of the compound of Formula (II) below and 0.05 g of p-hydroxyanisole as a polymerization inhibitor were added to a 300 ml four-neck flask equipped with a stirrer, a condenser tube, a thermometer and a dropping funnel. 38 g of acrylic acid and 1.5 g of tetraethylammonium bromide as a catalyst were added to the dropping funnel and mixed thoroughly. The four-neck flask was heated to 70° C., and the dropping funnel was switched to add the mixture therein dropwise at a rate of 1 drop per second, with stirring. After the completion of addition, the four-neck flask was heated to 100° C. and reacted for 8 hours, followed by cooling to room temperature. Thus, the epoxy acrylic resin was obtained.

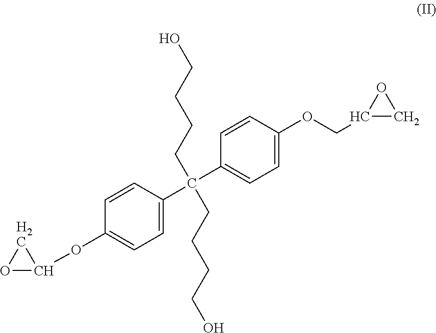 [SMILES: OCCCCC(CCCCO)(c1ccc(OCC2CO2)cc1)c1ccc(OC2CO2)cc1]

IR-spectrum (KBr) of the compound of Formula (II): 3500 cm⁻¹ (characteristic absorption peak of hydroxy group); 1455 cm⁻¹, 1506 cm⁻¹, 1572 cm⁻¹ and 1614 cm⁻¹ (characteristic absorption peaks of benzene ring); 1250 cm⁻¹ (absorption peak of aryl ether); 844 cm⁻¹ and 1535 cm⁻¹ (stretching vibration absorption peaks of bisphenol A skeleton); 915 cm⁻¹ (characteristic absorption peak of epoxy group).

IR-spectrum (KBr) of the resultant epoxy acrylic resin: 3500 cm⁻¹ (characteristic absorption peak of hydroxy group); 1640 cm⁻¹ (absorption peak of C=C); 1730 cm⁻¹ (absorption peak of carbonyl group of ester).

In the IR-spectrum of the epoxy acrylic resin, the absorption peak of epoxy group at 915 cm⁻¹ disappeared and the absorption band of hydroxy group around 3500 cm⁻¹ became wider and deeper, demonstrating that the ring of the oxirane group was opened to form a hydroxy group and that the epoxy acrylic resin represented by the formula shown in FIG. 2 with each R being a hydrogen atom was produced.

The resin composition was prepared by a process comprising the following steps:
mixing and stirring step, wherein the respective components of the resin composition were weighed in the proportion as described above and then fed into a horizontal helical ribbon mixer at room temperature and mixed for 30 minutes, thereby 200 g mixture of the resin composition was obtained;
compounding step, wherein the mixture of the resin composition was fed into a twin screw extruder at a temperature of 30° C. and compounded twice, each for 30 minutes;
deaerating step, wherein the resultant compounded mixture was deaerated twice at a pressure less than 100 Pa (gauge pressure: 90 Pa), each for 30 minutes. Thus, a resin composition having a viscosity of about 160 Pa·s was produced. The viscosity was measured by using a spinning viscometer (Brookfield) at a rate of 1 rpm at room temperature.

The deaerated resin composition was filtered, sealed, and preserved away from light for further use, wherein the sealing step was preferably performed in an environment having a cleaness degree of Class 1000.

### Example 2

This example provides a resin composition and a method of preparing the same. The resin composition comprises, based on the total mass of the composition:

65% of the epoxy acrylic resin represented by the formula shown in FIG. 2 wherein each R is a methyl group;

6% of p-aminophenol triglycidyl epoxy resin as an epoxy resin;

0.4% of N,N-dimethylaminoethyl methacrylate-diaryliodonium salt;

0.5% of silane coupling agent kh560 as a coupling agent;

14% of methylene bis(cyclohexylamine) as a heat curing agent;

5% of acrylic resin pellets having a D₉₀ particle size of 0.1 μm as an organic filler;

8% of silica pellets having a D₉₀ particle size of 1.0 μm as an inorganic filler; and

1.1% of KRNW925 (Kairui Chemical Co., Ltd.) as a heat-resistant anion exchange resin.

The epoxy acrylic resin was prepared by the process as described in Example 1, except that the acrylic acid was replaced by methacrylic acid.

The resin composition was prepared by a process comprising the following steps:
mixing and stirring step, wherein the respective components of the resin composition were weighed in the proportion as described above and then fed into a horizontal helical ribbon mixer at room temperature and mixed for 30 minutes, thereby 200 g mixture of the resin composition was obtained;
compounding step, wherein the mixture of the resin composition was fed into a twin screw extruder at a temperature of 50° C. and compounded thrice, each for 30 minutes;
deaerating step, wherein the resultant compounded mixture was deaerated twice at a pressure less than 200 Pa (gauge pressure: 150 Pa), each for 50 minutes. Thus, a resin composition having a viscosity of about 220 Pa·s was produced. The viscosity was measured by the method as described in Example 1.

The deaerated resin composition was filtered, sealed, and preserved away from light for further use, wherein the sealing step was preferably performed in an environment having a cleaness degree of Class 1000.

### Example 3

This example provides a resin composition and a method of preparing the same. The resin composition comprises, based on the total mass of the composition:

70% of the epoxy acrylic resin represented by the formula shown in FIG. 2 wherein each R is a isopropyl group;

7% of tetrahydrophthalic acid diglycidyl ester epoxy resin as an epoxy resin;

0.3% of N,N-dimethylaminoethyl methacrylate-diaryliodonium salt as a photoinitiator;

0.7% of silane coupling agent kh570 as a coupling agent;

10% of diethylenetriamine as a heat curing agent;

5% of rubber pellets having a D₉₀ particle size of 0.5 μm as an organic filler;

5% of silica pellets having a D₉₀ particle size of 0.7 μm as an inorganic filler; and

2% of KRNW925 (Kairui Chemical Co., Ltd.) as a heat-resistant anion exchange resin.

The epoxy acrylic resin was prepared by the process as described in Example 1, except that the acrylic acid was replaced by isopropyl acrylic acid.

The resin composition was prepared by a process comprising the following steps:
mixing and stirring step, wherein the respective components of the resin composition were weighed in the proportion as described above and then fed into a horizontal helical ribbon mixer at room temperature and mixed for 30 minutes, thereby 200 g mixture of the resin composition was obtained;
compounding step, wherein the mixture of the resin composition was fed into a twin screw extruder at a temperature of 40° C. and compounded twice, each for 30 minutes;
deaerating step, wherein the resultant compounded mixture was deaerated twice at a pressure less than 150 Pa (gauge pressure: 120 Pa), each for 40 minutes. Thus, a resin composition having a viscosity of about 180 Pa·s was produced. The viscosity was measured by the method as described in Example 1.

The deaerated resin composition was filtered, sealed, and preserved away from light for further use, wherein the sealing step was preferably performed in an environment having a cleaness degree of Class 1000.

### Example 4

This example provides a resin composition and a method of preparing the same. The resin composition comprises, based on the total mass of the composition:

62% of the epoxy acrylic resin represented by the formula shown in FIG. 2 wherein each R is a neopentyl group;

6.5% of hexahydrophthalic acid diglycidyl ester as an epoxy resin;

0.6% of camphorquinone as a photoinitiator;

0.9% of silane coupling agent kh550 as a coupling agent;

14% of triethylenetetramine as a heat curing agent;

5.5% of rubber pellets or acrylic resin pellets having a D₉₀ particle size of 0.3 μm as an organic filler;

9% of silica pellets having a D₉₀ particle size of 0.8 μm as an inorganic filler; and

1.5% of KRNW925 (Kairui Chemical Co., Ltd.) as a heat-resistant anion exchange resin.

The epoxy acrylic resin was prepared by the process as described in Example 1, except that the acrylic acid was replaced by neopentyl acrylic acid.

The resin composition was prepared by a process comprising the following steps:
mixing and stirring step, wherein the respective components of the resin composition were weighed in the proportion as described above and then fed into a horizontal helical ribbon mixer at room temperature and mixed for 30 minutes, thereby 200 g mixture of the resin composition was obtained;
compounding step, wherein the mixture of the resin composition was fed into a twin screw extruder at a temperature of 45° C. and compounded twice, each for 30 minutes;
deaerating step, wherein the resultant compounded mixture was deaerated twice at a pressure less than 100 Pa (gauge pressure: 90 Pa), each for 45 minutes. Thus, a resin composition having a viscosity of about 200 Pa·s was produced. The viscosity was measured by the method as described in Example 1.

The deaerated resin composition was filtered, sealed, and preserved away from light for further use, wherein the sealing step was preferably performed in an environment having a cleaness degree of Class 1000.

### Testing Example

The resin composition produced in Example 1 was used as a sealant and the reactivity ratio of acrylic resin was tested at the following conditions:

Wavelength: 340 nm, 400 nm, 425 nm, 450 nm

Irradiation dose: 1000 mJ/cm², 2000 mJ/cm², 3000 mJ/cm²

The results are reported in Table 1 below. The reactivity ratio of acrylic resin was tested with a FT-IR spectrometer by a process as shown in FIG. 3. The reactivity ratio is calculated according to the following equation:

$$Reactivity = 1 - ( \frac{\frac{Pac ( curedsealant )}{Pref ( curedsealant )}}{\frac{Pac ( uncuredsealant )}{Pref ( uncuredsealant )}} )$$

wherein Pac(uncuredsealant) and Pac(curedsealant) refer to the absorption peak of acrylic group in the composition (i.e., sealant) before or after curing, respectively; Pref(uncuredsealant) and Pref(curedsealant) refer to the absorption peak of a reference group (herein, phenyl group) in the composition (i.e., sealant) before or after curing, respectively. The reactivity ratio is typically reported as a percentage (%), i.e., the Reactivity of the above equation multiplied by 100%.

It can be seen from Table 1 that when the resin composition of Example 1 was irradiated by the light having a wavelength in the rage of 400-450 nm (liquid crystals are insusceptible to such light), the reactivity ratio of acrylic resin was comparable to the reactivity ratio of acrylic resin when the same composition was irradiated by the light having a wavelength of 340 nm (liquid crystals are susceptible to such light). Thus, by using the resin composition of Example 1, good bonding strength can be ensured when UV irradiation is replaced by visible light irradiation.

TABLE 1
Reactivity ratio of acrylic resin of the resin composition tested

| | Reactivity ratio of acrylic resin (%) | | |
|---|---|---|---|
| Wavelength | Irradiation dose | Irradiation dose | Irradiation dose |
| (nm) | (1000 mJ/cm²) | (2000 mJ/cm²) | (3000 mJ/cm²) |
| 340 | 87.9 | 88.4 | 88.2 |
| 400 | 87.5 | 87.9 | 87.3 |
| 425 | 85.3 | 86.1 | 85.8 |
| 450 | 82.9 | 83.5 | 83.2 |

A test was performed to evaluate the influence of light irradiation having a wavelength of 400-450 nm on a liquid crystal. The degree of denaturalization of the liquid crystal subjected to the irradiation was characterized by voltage holding ratio, since the existing liquid crystals tend to produce polar impurities upon exposure to short wavelength UV irradiation such that the voltage holding ratio thereof decreases. A liquid crystal, BOE-F013 (Merck, ADS type), was subjected to a irradiation at a dose of 3000 mJ/cm², followed by the measurement of its voltage holding ratio under the following conditions: 60 Hz, 20° C. and 100° C. The results are reported in Table 2 below. The voltage holding ratios of the liquid crystal subjected to an irradiation of 400-450 nm (the wavelength range over which the resin composition can be photopolymerized) are substantially the same as those before the irradiation.

TABLE 2
Voltage holding ratio of the liquid crystal tested

Irradiation dose (3000 mJ/cm²)

| Irradiation wavelength (nm) | 20° C. | 100° C. |
|---|---|---|
| Before irradiation | 99.8% | 97.9% |
| 400 | 99.8% | 97.9% |
| 425 | 99.8% | 97.8% |
| 450 | 99.8% | 97.7% |

The test results of Examples 2, 3 and 4 (similar to the results of Example 1) also demonstrate that the resin compositions produced according to the embodiments of the present invention can be applied to the irradiation of 400-450 nm (the wavelength range over which the resin composition can be photopolymerized) and can still ensure good bonding strength, while the voltage holding ratios of liquid crystals are not affected. Therefore, the distance from the edge of the mask to the outer edge of the display area can be set to less than 0.2 mm, and thus the width of the LCD panel frame can be reduced.

### Example 5

This example provides a LCD panel comprising an array substrate and a color filter substrate, wherein the resin composition described above was disposed between the array substrate and the color filter substrate as a sealant to bond and enclose the substrates. Due to the resin composition, photocuring can be carried out by a irradiation of visible light which has no influence on liquid crystals. Therefore, the distance from the edge of the mask to the outer edge of the display area can be set to less than 0.2 mm, and thus the width of the LCD panel frame can be reduced.

It should be understood that the present invention is not intended to be limited to the embodiments set forth above for illustrative purposes. Various modifications and alterations of the invention will be apparent to those skilled in the art without departing from the scope and spirit of the invention. Such modifications and alterations are included in the scope of the present invention.

1. A resin composition comprising an epoxy acrylic resin, characterized in that the epoxy acrylic resin is represented by the following Formula (I): 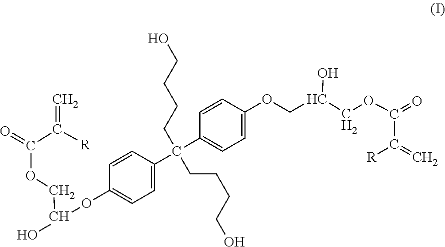
wherein each R is independently a hydrogen atom, or an alkyl substituent having a carbon atom number of less than 6.

2. The resin composition according to claim 1, characterized in that the alkyl substituent having a carbon atom number of less than 6 is any one selected from methyl, ethyl, n-propyl, isopropyl, n-butyl, isobutyl, tert-butyl, n-pentyl, isopentyl and neopentyl.

3. The resin composition according to claim 1, characterized in that the resin composition further comprises a photoinitiator capable of inducing a photocuring reaction of the epoxy acrylic resin under the irradiation of visible light.

4. The resin composition according to claim 3, characterized in that the photoinitiator is camphorquinone or N,N-dimethylaminoethyl methacrylate-diaryliodonium salt.

5. The resin composition according to claim 1, characterized in that the resin composition further comprises:
an epoxy resin;
a photoinitiator;
a coupling agent;
a heat curing agent;
an organic filler;
an inorganic filler; and
optionally, a heat-resistant anion exchange resin.

6. The resin composition according to claim 5, characterized in that the epoxy resin has a number-average molecular weight in the range of 380-1000.

7. The resin composition according to claim 5, characterized in that the photoinitiator is camphorquinone or N,N-dimethylaminoethyl methacrylate-diaryliodonium salt.

8. The resin composition according to claim 5, characterized in that the coupling agent is a silane coupling agent which is any one selected from kh550, kh560 and kh570.

9. The resin composition according to claim 5, characterized in that the organic filler is an organic pellet filler having a D₉₀ particle size in the range of 0.1-1.0 μm.

10. The resin composition according to claim 9, characterized in that the organic pellet filler is selected from rubber pellets and acrylic resin pellets.

11. The resin composition according to claim 5, characterized in that the inorganic filler is an inorganic pellet filler having a D₉₀ particle size in the range of 0.1-1.0 μm.

12. The resin composition according to claim 11, characterized in that the inorganic pellet filler is silica pellet.

13. The resin composition according to claim 1, characterized in that the resin composition comprises 60-70% of the epoxy acrylic resin, based on the total mass of the resin composition.

14. The resin composition according to claim 13, characterized in that the resin composition further comprises, based on the total mass of the resin composition:
5% -7% of an epoxy resin;
0.1-0.5% of a photoinitiator;
0.5% -1% of a coupling agent;
10% -15% of a heat curing agent;
4% -6% of an organic filler;
5% -11% of an inorganic filler; and
0% -2% of a heat-resistant anion exchange resin.

15. The resin composition according to claim 14, characterized in that the heat-resistant anion exchange resin is present at an amount of 0.5% -2% by the total mass of the resin composition.

16. The resin composition according to claim 1, characterized in that the resin composition has a viscosity in the range of 150-250 Pa·s.

17. A liquid crystal display panel comprising an array substrate, a color filter substrate, and a sealant bonding the array substrate and the color filter substrate, characterized in that the sealant is a cured resin composition, wherein the resin composition comprises an epoxy acrylic resin represented by the following Formula (I): 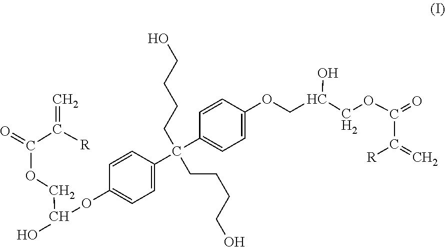
wherein each R is independently a hydrogen atom, or an alkyl substituent having a carbon atom number of less than 6.

18. A method of using a resin composition, comprising the following steps:
1) providing a resin composition that comprises an epoxy acrylic resin represented by the following Formula (I): 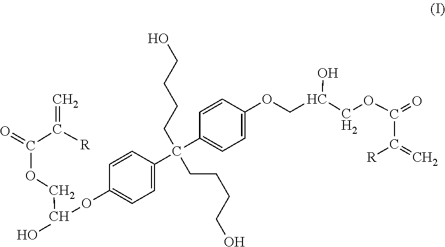
wherein each R is independently a hydrogen atom, or an alkyl substituent having a carbon atom number of less than 6; and
2) irradiating the resin composition with visible light to induce curing of the composition.

19. The method according to claim 18, further comprising:
applying the resin composition provided in step 1) onto a frame of a color filter substrate and/or an array substrate.

20. The method according to claim 18, wherein the visible light has a wavelength in the range of 400-450 nm.
